(19) United States
(12) Patent Application Publication
(10) Pub. No.: US 2012/0217233 A1
(43) Pub. Date: Aug. 30, 2012

(54) PTC CONTROLLED ENVIRONMENT HEATER

(75) Inventors: Howard J. Base, Macedonia, OH (US); Derrick L. Sanislo, Thompson, OH (US)

(73) Assignee: Tom Richards, Inc.

(21) Appl. No.: 13/398,354

(22) Filed: Feb. 16, 2012

Related U.S. Application Data
(60) Provisional application No. 61/447,252, filed on Feb. 28, 2011.

(51) Int. Cl. H05B 3/12; H05B 3/44

(52) U.S. Cl. 219/534; 219/553

(57) ABSTRACT

A sealed self regulating heater assembly includes a positive temperature coefficient (PTC) heating element and a pair of spaced electrodes. Each electrode includes a first surface with the first surfaces of the pair of electrodes being spaced from one another, such that the PTC element is located between the first surfaces of the pair of electrodes and is energized by the pair of electrodes. A sheath surrounds the pair of electrodes in the PTC element. First and second closures are located at opposed end of the sheath with the sheath and the closures cooperating to define an interior space. An electrically insulative and thermally conductive film material is disposed within the interior space and a supply of oxygen is provided to the interior space.

This application claims the priority of Provisional Application Ser. No. 61/447,252 which was filed on Feb. 28, 2011 and the subject matter of which is incorporated hereinto in its entirety.

### BACKGROUND

The present disclosure relates generally to heater assemblies. More particularly, it relates to a self regulating heater assembly which comprises a positive temperature coefficient heating device. The heater assembly is adapted for use in hostile environments.

Self regulating heater assemblies are well known in the art. A positive temperature coefficient (PTC) heating device is a semiconductor which has an electrical resistance that is temperature sensitive. The electrical resistance of the PTC device varies proportionally with temperature. PTC devices are generally available as ceramics or polymers and are well known for use in temperature sensors, current limiters and heaters. Their usefulness as a heater is particularly attractive due to the fact that a self regulating heater can be constructed.

When a current is passed through a PTC device, it produces heat by virtue of the internal resistance of the PTC device. The resultant current is similar to that of other resistance heaters except that at a certain predetermined temperature (the query point or auto stabilizing temperature) the resistance begins to increase virtually exponentially. This causes the power to decrease. Thus, the PTC device auto stabilizes at a particular predetermined temperature. The temperature at which such auto stabilization occurs varies depending upon the specifics of the PTC device. Such auto stabilizing temperature feature of the PTC device is useful because it can be established at a temperature that is below the ignition temperature of the heater environment or the melt point of a chemically resistant fluoropolymer coating that can be applied to the heating device.

PTC self regulating heaters have not been particularly successful in the prior art when used in hostile environments, such as in the chemical processing industry. In such environments, strong oxidizers, free halogen ions and strong reducing acids contribute to the degradation of PTC heater assemblies.

PTC devices used as heating elements are also currently employed in an open or not sealed environment. Typically, the PTC device is held by some mechanical means between two electrical conductors that also act as heat sinks to both energize and dissipate the resultant heat generated. Various methods and techniques have been developed in an attempt to maximize the heat output of the PTC device and to reduce the overall cost of the assembly. In these uses, the packaging of the PTC chip results in an assembly which allows the PTC element to have direct contact with the environment in which the assembly is used. This is obviously impossible in corrosive environments where the heating element is intended for direct immersion in various liquids or fluids that may be corrosive. These uses require that the PTC heating element be sealed from the environment in which it will be used in order to allow for a long, safe, useful service life.

One known such PTC heating advice adapted for hostile environments is described in U.S. Pat. No. 7,034,259. Another known such PTC heating device is described in U.S. Patent Publication No. 2010/0200569 which was published on Aug. 12, 2010. Both the patent and the application are owned by the assignee of the instant application. The disclosures of both of these patent documents are incorporated hereinto by reference in their entireties.

Another relevant factor is that PTC heating technology employed for direct immersion heaters is unique in that it requires relatively high power outputs and higher voltages than what is typically used for unsealed heaters. Most PTC heaters in common use have a capacity of less than 1000 watts. However, direct immersion heaters can vary in capacity from 100 watts up to 24,000 watts. The high power and voltage applications of certain direct immersion heaters greatly reduce the useful service life of the PTC heating element if used in a completely sealed construction. In fact, an unexpected failure mechanism was discovered when sealed heaters were employed in corrosive environments. It was determined that the mechanism by which the PTC element was failing when sealed was a reduction of the dielectric strength of the PTC substrate.

Typically, the PTC heating device can withstand a voltage nearly three times the designed application voltage. It was found, however, that if the PTC heating element was operated in a sealed environment, over time, the dielectric strength would decline until it became less than the applied voltage. Then, a direct fault would occur between the electrodes supplying the voltage. The precise mechanism by which the reduction of dielectric strength occurred was determined to be a reduction of the available oxygen in the sealed package. When all of the available oxygen was reduced, then the oxygen was pulled from the PTC substrate. This resulted in a lowering of the dielectric strength of the PTC device to the point of failure.

The materials employed in the construction of PTC heating packages required the use of metals which are good electrical conductors, as well as being good thermal conductors. Of course, cost is also an important consideration so that efficient use of all available materials that are reasonable in cost is important. It has been found that the materials employed will oxidize over time depleting the available oxygen in the overall package. In order to make a PTC based heating product with an acceptably long service life, additional oxygen needs to be added to the sealed heater in order to supply enough oxygen to the heater so that the oxygen will not be pulled from the PTC device itself, thus maintaining the dielectric strength required.

Accordingly, it has been considered desirable to develop an improved self regulating heater assembly which would overcome the foregoing difficulties and others while providing better and more advantageous overall results.

### BRIEF DESCRIPTION OF THE DISCLOSURE

In one embodiment, the present disclosure pertains to a sealed self regulating heater assembly comprising a positive temperature coefficient (PTC) heating element and a pair of spaced electrodes, wherein each electrode includes a first surface, the first surfaces of the pair of electrodes being spaced from one another, wherein the PTC element is located between the first surfaces of the pair of electrodes and is energized by the pair of electrodes. A sheath surrounds the pair of electrodes and the PTC element and first and second closures are located at opposed ends of the sheath. The sheath and the closures cooperate to define an interior space. An electrically insulative and thermally conductive fill material is disposed within the interior space. A means is provided for supplying oxygen to the interior space.

In accordance with another aspect of the present disclosure, provided is a sealed self regulating heater assembly comprising a positive temperature coefficient (PTC) heating element and a pair of spaced electrodes, which each electrode including a first surface, the first surfaces of the pair of electrodes being spaced from one another. The PTC element is located between the first surfaces of the pair of electrodes and is energized by the pair of electrodes. A cylindrical sheath encases the pair of electrodes in the PTC element. First and second closures are located at opposed ends of the sheath, with the sheath and the pair of closures cooperating to define an interior space in which the pair of spaced electrodes and the PTC element are located in a manner sealed from ambient. An electrically insulative and thermally conductive film material is disposed in the interior space. A protective sleeve surrounds the sheath to protect the sheath from hostile environments. A means is provided for supplying oxygen to the interior space.

Still other aspects of the disclosure will become apparent from a reading and understanding of the detailed description of the embodiments hereinbelow.

### BRIEF DESCRIPTION OF THE DRAWINGS

The present disclosure may take physical form in certain parts and arrangements of parts, several embodiments of which will be described in detail in this specification and illustrated in the accompanying drawings which form a part hereof and wherein:

FIG. 1 is a perspective view, partially broken away, of a self regulating heater assembly according to one embodiment of the present disclosure;

FIG. 2 is a top plan view of another embodiment of the self regulating heater assembly according to the present disclosure; and,

FIG. 3 is a perspective view partially broken away of a self regulating heater assembly according to a further embodiment of the present disclosure.

### DETAILED DESCRIPTION OF THE PREFERRED EMBODIMENTS

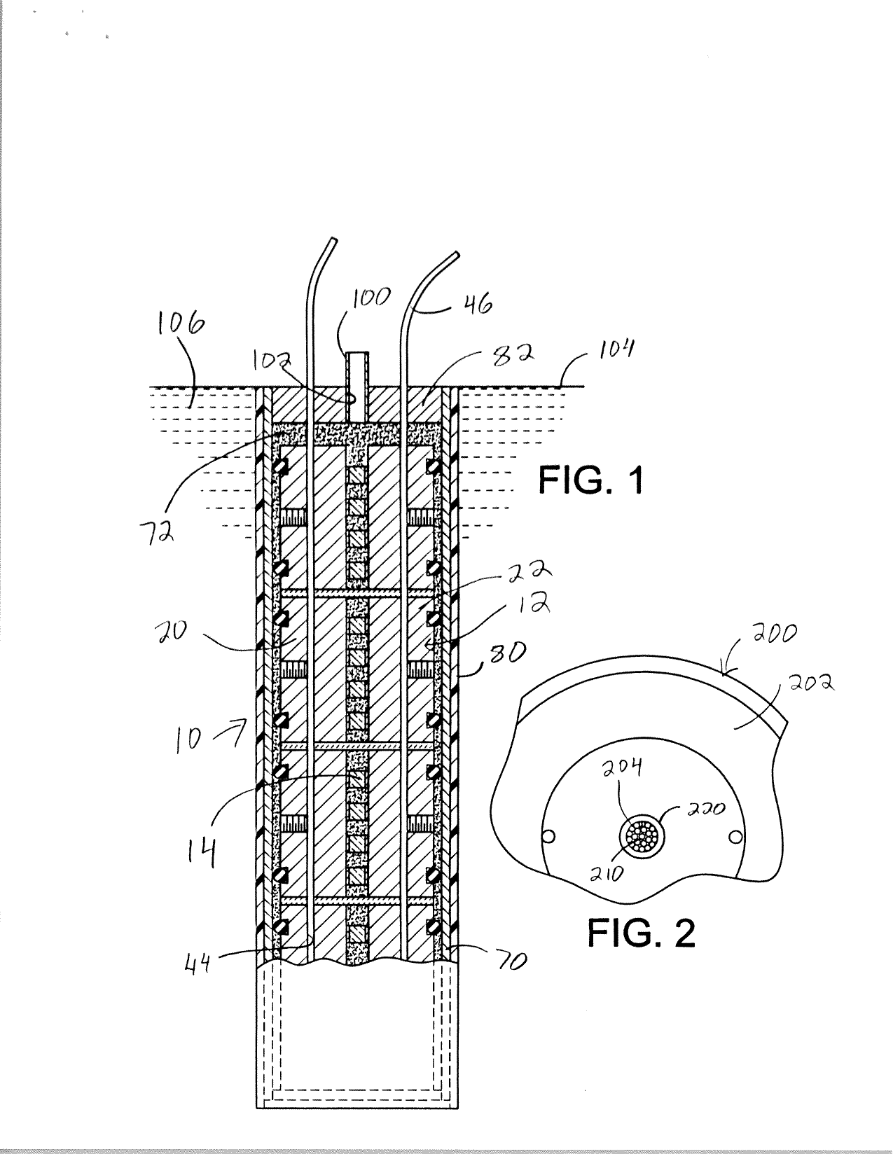

Referring now to the drawings, wherein the showings illustrate the preferred embodiments of the disclosure only and are not intended to limit same FIG. 1 shows a self regulating heater assembly 10 in accordance with the first embodiment of the present disclosure. In this embodiment, the self regulating heater assembly 10 is oriented to extend along a generally vertical axis. Therefore, the terms upper and lower will be used to describe certain structures of the heater assembly. It should be recognized, however, that if the heater assembly were to be oriented along other directions, the terms upper and lower may lose their respective meaning.

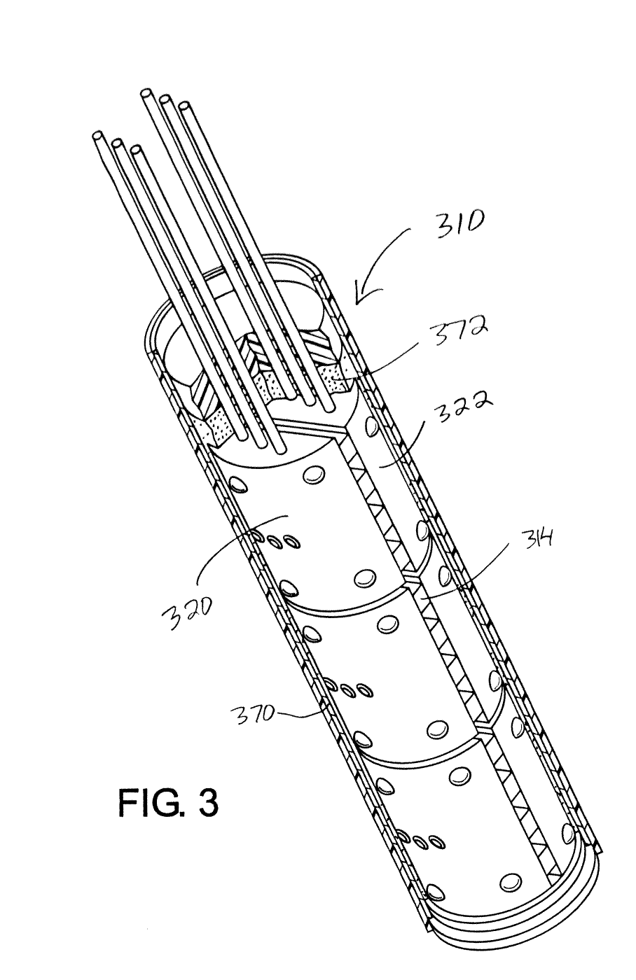

The heater assembly 10 comprises a plurality of spaced heating sections 12. Each heating section includes at least one positive temperature coefficient (PTC) heating element 14. In one embodiment, the PTC element can be rectangular in shape and include a pair of opposed generally planar surfaces. The heating section 12 also includes a pair of low electrical resistance current conducting electrodes 20 and 22 for energizing the PTC element. The pair of electrodes 20 and 22 can be made from a suitable metallic material such as electrical grade copper or aluminum alloys or the like. Extending through each of the electrodes is at least one bore 44 that is sized for receiving a power lead 46. FIG. 3 illustrates a conventional design in which three such power leads are provided in a three-phase delta configuration. Of course, more or less than that number of power leads could be employed for energizing each electrode.

A sheath 70 encloses the electrodes. The sheath 70 simplifies the construction of the self regulating heater assembly. Disposed between the sheath 70 and the electrodes is a suitable electrically insulative and thermally conductive fill material or product 72. This is meant to fill any voids between the electrodes and the sheath and also between the pair of electrodes. The fill material 72 can be formed from magnesium oxide or zirconium oxide, although other suitable electrically insulative and thermally conductive materials can be used as well.

A protective sleeve 80 can surround the sheath 70 to further protect the self regulating heater assembly from hostile environments. The sleeve 80 can be made from a thick walled chemical and heat resistant polymer material, such as fluorocarbon polymer, ethylenated fluorocarbon polymer, chlorinated fluorocarbon polymer, polyvinyl fluorocarbon polymer, perfluoroalkoxy polymers, or combinations thereof, as is known in the art. Depending on the solution which is meant to be heated, the protective sleeve can be made of any appropriate material, such as glass, plastic or metal. In some embodiments, such sleeve may not be necessary. A heat resistant potting compound 82 can be placed into an upper portion of the heater assembly in order to seal the upper portion against the fluid in which the heater assembly is immersed. This can form an upper end cap or first end closure of the assembly. The lower end of the heater assembly is suitably sealed by an end cap 84 or the like closure. Also, an insulator 86 can be employed if so desired.

Extending through apertures in the potting compound are the leads 46 for the electrodes.

In this embodiment, a tube 100 extends through a suitable aperture 102 defined in the potting compound 82. The purpose for the tube is to serve as a vent tube which allows additional oxygen to enter from a controlled location outside of the fluid that is to be heated by the PTC heating element. Due to the presence of this tube, the available oxygen in the otherwise sealed PTC heating element is always replenished so that the oxygen is not pulled from the PTC substrate, thereby lowering the dielectric strength of the PTC device to the point of failure. Needless to say, the tube 100 has to be long enough so that its upper end extends above a surface 104 of a liquid 106 in which the heating assembly including the PTC heating element is placed or immersed.

The diameter of the two can be on the order of 2 inches (5.08 cm) or so. A range of acceptable diameters can be from 0.25 inch up to 4 inches (0.635 to 10.16 cm). The length of the tube can be longer than the length needed to reach the surface of the liquid in which the PTC heating element is placed or immersed. In fact, tubes up to 20 feet (6.1 m) in length have been used. The proximal end of the tube can be open to the environment or to the ambient outside the liquid in which the heater is immersed. Alternatively, the proximal end of the tube could be connected to a supply of oxygen instead of the atmosphere.

With reference now to FIG. 2, another embodiment of a heater according to the present disclosure is there illustrated. In FIG. 2, a PTC heater 200 includes an upper end 202. An interior space of the sealed heater is filled with a potting compound. Extending through the potting compound is a bore or aperture 204 which allows communication with the interior of the PTC heating assembly 200. Extending through the aperture 204 is a means for allowing oxygen to enter the otherwise sealed enclosure. In this embodiment, the means for allowing communication comprises a stranded elongated member 210 contained in a tube section 220. The strands can comprise wire material or suitable types of elongated thermoplastic materials. It should be appreciated that interstices or gaps are defined between each strand. Such interstices or gaps allow the communication of the interior of the PTC heater 200 with the atmosphere in order to allow oxygen to flow into the PTC heater 200. So as to prevent the corrosive material in which the PTC heater is immersed from entering the PTC heater, the stranded material is surrounded by the tube section 220, such as the tube illustrated in FIG. 1. One benefit of the stranded material is that it helps retard the fill material from falling out of the PTC heater when it is being installed for use or during transportation when the heater may not be vertically oriented.

The strands or elongated members 210 can be generally parallel to each other and generally parallel to an axis of the tube. As mentioned, the strands help to keep the fill material from falling out of the heater assembly, while allowing enough flow of oxygen or ambient air into the sealed heater to maintain sufficient oxygen in the assembly so that oxygen is not pulled out from the PTC substrate.

With reference now to FIG. 3, a still further embodiment of the present disclosure is there illustrated. In this embodiment, a sealed PTC heater assembly 310 meant for immersion includes a plurality of PTC chips 314 which are disposed between a pair of electrode members 320 and 322. A suitable dielectric fill material 372 is disposed between the electrodes and a sheath 370 surrounding the electrodes. In this embodiment, the fill material includes not only a conventional magnesium oxide (MgO) or zirconium oxide (ZrO), but also an additional component. More particularly, an oxidizer, such as magnesium peroxide (MgO₂), is added to the dielectric fill material in the interior space, for example, between the heater sheath 370 and the electrodes 320 and 322. The oxidizer is blended into the dielectric fill material in order to prevent oxygen loss in the PTC substrate during use of the heater assembly 310.

The amount of oxidizer added to the fill material can be in the ratio of about 1 to 50. Put another way, the ratio can be 50 parts of MgO to one part of MgO₂. The acceptable range of the weight or amount of oxidizer added can be anywhere from 10 to 1 to 100 to 1. The weight percent of oxidizer to fill material can be on the order of 2 percent. An acceptable range of the oxidizer to the fill material can be from 1 percent to 10 percent.

It should be recognized that oxidizers other than magnesium peroxide (MgO₂) can be used for blending with the fill material. However, two advantages of magnesium peroxide are that it is a) cost effective and b) safe.

The means for providing oxygen to the otherwise sealed heater assembly has increased the service life of the heater assembly to a degree which is required in order to be competitive in the marketplace. The heater assemblies can last on the order of 1 to 2 years or more without failures attributed to oxygen being pulled from the PTC substrate, thereby lowering the dielectric strength of the PTC device to the point of failure.

Disclosed has been a self regulating heater assembly which comprises at least one positive temperature coefficient (PTC) heating element and a pair of spaced electrodes such that the heating element is located between and supported by and energized by the pair of electrodes. The combination of the pair of spaced electrodes and the at least one PTC heating element comprises a heating section. A metallic sheath encases the heating section and an electrically insulative and thermally conductive fill material is located between the metallic sheath and the heating section. The heating section further includes a pair of spaced power leads wherein a respective one of the pair of power leads is connected to a respective one of the pair of spaced electrodes of the heating section. The ends of the metal tube are sealed off with end caps or a potting compound.

At an upper end of the heater assembly, an aperture can be disposed in the end cap or potting compound. Extending through the aperture and into the atmosphere or to a dedicated oxygen supply can be a tube or other means for allowing oxygen from the atmosphere or from the oxygen supply to enter the otherwise sealed PTC heater assembly. Alternatively, an oxidizer can be added to the fill material in order to supply the required additional oxygen to the sealed heater assembly

The present disclosure has been described with reference to several preferred embodiments. Obviously, modifications and alterations will occur to others upon a reading and understanding of the preceding detailed description. It is intended that the disclosure not be limited to the embodiments described. Rather, the disclosure should be construed as including all such modifications and alterations as come within the scope of the appended claims or the equivalents thereof.

1. A sealed self regulating heater assembly, comprising:
a positive temperature coefficient (PTC) heating element;
a pair of spaced electrodes, each electrode including a first surface, the first surfaces of the pair of electrodes being spaced from one another, wherein the PTC element is located between the first surfaces of the pair of electrodes and is energized by the pair of electrodes;
a sheath surrounding the pair of electrodes and the PTC element;
first and second closures located at opposed ends of the sheath, the sheath and the closures cooperating to define an interior space;
an electrically insulative and thermally conductive fill material disposed within the interior space; and
a means for supplying oxygen to the interior space.

2. The assembly of claim 1 wherein the means comprises a tube extending through one of the first and second closures and communicating with the fill material at a first end of the tube.

3. The assembly of claim 2 wherein the tube communicates at a second end thereof with the environment.

4. The assembly of claim 2 further comprising a retarding element located in the tube for retarding the fill material from leaving the interior space.

5. The assembly of claim 4 wherein the retarding element comprises a plurality of strands.

6. The assembly of claim 5 wherein an axis of the plurality of strands is aligned with an axis of the tube.

7. The assembly of claim 1 wherein the means comprises an oxidizer material added to the fill material.

8. The assembly of claim 6 wherein the oxidizer material comprises magnesium peroxide (MgO₂).

9. The assembly of claim 7 wherein the oxidizer material comprises from 1 to 10 weight % of the fill material.

10. The assembly of claim 1 further comprising a pair of power leads, one power lead being connected to each of said pair of electrodes for energizing said pair of electrodes.

11. A sealed self regulating heater assembly comprising:
a positive temperature coefficient (PTC) heating element;
a pair of spaced electrodes, each electrode including a first surface, the first surfaces of the pair of electrodes being spaced from one another, wherein the PTC element is located between the first surfaces of the pair of electrodes and is energized by the pair of electrodes;
a cylindrical sheath encasing the pair of electrodes and the PTC element;
first and second closures located at opposed ends of the sheath, the sheath and the pair of closures cooperating to define an interior space in which the pair of spaced electrodes and the PTC element are located in a manner sealed from ambient;
an electrically insulative and thermally conductive fill material disposed in the interior space;
a protective sleeve surrounding the sheath to protect the sheath from hostile environments; and
a means for supplying oxygen to the interior space.

12. The assembly of claim 11 wherein the means for supplying oxygen comprises a tube extending through one of the first and second closures, said tube including a first end and a second end, said tube first end extending into the fill material.

13. The assembly of claim 12 wherein the second end of the tube communicates with a supply of oxygen.

14. The assembly of claim 13 wherein the supply of oxygen is the environment.

15. The assembly of claim 11 wherein the means for supplying oxygen comprises an oxidizer material blended into the fill material.

16. The assembly of claim 15 wherein the oxidizer material comprises magnesium peroxide (MgO₂) and the fill material comprises at least one of magnesium oxide (MgO) and zirconium oxide (ZrO).

17. The assembly of claim 15 wherein the oxidizer material comprises from 1 to 10 weight % of the fill material.

18. The assembly of claim 12 further comprising a retarding element located in the tube for retarding the fill material from leaving the interior space.

19. The assembly of claim 18 wherein the retarding element comprises a plurality of strands.

20. The assembly of claim 19 wherein an axis of the plurality of strands is aligned with an axis of the tube.
